(19) United States
(12) Patent Application Publication
(10) Pub. No.: US 2024/0297769 A1
(43) Pub. Date: Sep. 5, 2024

(54) SPECTRUM CONTROLLER FOR MITIGATING CO-SITE INTERFERENCE

(71) Applicant: Booz Allen Hamilton Inc., McLean, VA (US)

(72) Inventor: Sherman Couch, McLean, VA (US)

(73) Assignee: Booz Allen Hamilton Inc., McLean, VA (US)

(21) Appl. No.: 18/116,171

(22) Filed: Mar. 1, 2023

(51) Int. Cl. H04L 5/00; H04W 28/02; H04W 72/0453; H04W 72/27

(52) U.S. Cl. CPC H04L 5/0073; H04W 28/0236; H04W 72/0453; H04W 72/27

(57) ABSTRACT

Systems for co-site interference mitigation are provided herein. A system according to an embodiment receives first spectrum usage data indicating parameters to be used by a first group of one or more radio elements to send or receive transmissions. The system receives second spectrum usage data indicating parameters to be used by a second group of one or more radio elements to send or receive transmissions. The system dynamically determines, based on the first and second spectrum usage data received in real time, that interference will occur between the first group and the second group. The system forwards, to the at least one of the radio elements, a signal indicating parameters for mitigating the interference between transmissions to be sent or received by the radio elements of the first or second group. The system sends or receives a transmission in accordance with the sent signal.

### FIELD OF INVENTION

The present invention relates to the field of radio frequency communications, and more specifically to interference mitigation techniques for platforms having co-sited radio equipment.

### BACKGROUND

Co-site interference is a specialized challenge faced in radio frequency (RF) communications. A basic co-site environment may be found where radios are located near each other (e.g. at a co-located site, at the same site “co-sited” on platforms such as aircraft, ship, vehicle, satellite, or fixed site platforms), presenting challenges with interoperability. This is largely because the energy emitted by transmitting radio(s) is not completely confined within the channel(s) to which the transmitters are tuned.

In radio communications, a channel may be understood as a portion of radio spectrum (frequency) above and below a center frequency. This center frequency is commonly referred to as the “tune frequency.” For example, in radio systems with 25 kHz channel spacing (e.g., many Air Traffic Control (ATC) Very High Frequency (VHF) communication systems, Single Channel Ground and Airborne Radio System (SINCGARS)), the channel spans 12.5 kHz below the tune frequency and 12.5 kHz above the tune frequency. Many other frequency channelization strategies are used. For example, other ATC communication systems use a 8.33 kHz channel spacing. In these cases, the channel spans 4.17 kHz below the tune frequency and 4.17 kHz above the tune frequency.

The most salient problem stemming from co-site interference is that energy from a transmission from one radio can appear outside its transmit channel and overload the receive circuitry or logic (also known as the receiver's “front end,” which includes a local oscillator/down convert circuit) of a traditional radio that is tuned to a different channel. This commonly results in making the aforementioned receiver less sensitive, and this effect is commonly called “receiver desensitization”. Similar receiver desensitization effects are seen in more modern software defined radios as well. This overload results in desensitization of the victim receiver to signals of interest, thus degrades receive performance, and in extreme cases, renders the victim receiver radio unable to receive signals of interest.

In these scenarios, the victim receiver receives erroneous signal and error injections, or it can be deafened entirely to signals that would ordinarily be within the receiver's sensitivity. This desensitization phenomenon is at the heart of what those knowledgeable in the art refer to as “the co-site interference problem.” While co-site interference most commonly results in a transient receiver desensitization (or even deafening), in some extreme cases, the victim receiver can itself be damaged.

### SUMMARY

Systems for co-site interference mitigation are provided herein. A system according to one embodiment receives first spectrum usage data indicating parameters to be used by a first group of one or more radio elements to send or receive transmissions. The system receives second spectrum usage data indicating parameters to be used by a second group of one or more radio elements to send or receive transmissions. The system dynamically determines, based on the first and second spectrum usage data received in real time, that interference will occur between the first group and the second group. The system forwards, to at least one of the radio elements, a signal indicating parameters for mitigating the interference between transmissions to be sent or received by the radio elements of the first or second group. A radio element sends or receives a transmission in accordance with the sent signal.

According to an embodiment, a first group of one or more radio elements of the system sends or receives transmissions in a first spectral band, and the second group of one or more radio elements is sends or receives transmissions in a second spectral band.

According to an embodiment, the first spectral band is an ultra high frequency (UHF) band, and the second band is a very high frequency (VHF) band.

According to an embodiment, the first group of one or more radio sends or receives transmissions using a first frequency hopping pattern, and the second group of one or more radio elements sends or receives transmissions using a second frequency hopping pattern.

According to an embodiment, the parameters for mitigating the interference between transmissions sent or received by the one or more radio elements of the first group and the one or more radio elements of the second group include one or more of: filtering parameters, attenuation parameters, transmit blanking parameters, receive blanking parameters, receive frequency parameters, transmit frequency parameters, channel assignment parameters, phase cancellation parameters, or timing parameters.

According to an embodiment, a spectrum controller is configured to forward the signal indicating parameters for mitigating interference directly to at least one of the radio elements of the first group or the second group.

According to an embodiment, the spectrum controller is coupled to an external device, and the external device is coupled to at least one of the radio elements of the first group or the second group so as to control the sending or receiving of transmissions in accordance with the signal forwarded by the spectrum controller.

According to an embodiment, a multicoupler is coupled to at least one of the first or second group of radio elements, and the multicoupler is configured to provide spectrum usage data to the spectrum controller. The multicoupler is configured to condition signals transmitted by at least one of the first or second group of radio elements.

According to an embodiment, the multicoupler mitigates co-site interference among the first or second group of radio elements to which the multicoupler is coupled.

According to an embodiment, the spectrum controller receives configuration information from a configuration terminal indicating one or more of: a priority level associated with at least one of the radio elements of the first group or the second group, channel assignment information, channel restriction information, or hop-set information.

### BRIEF DESCRIPTION OF THE DRAWING(S)

FIG. 1A is a diagram illustrating one example of a co-site environment present at a communications platform;

FIG. 1B is a diagram illustrating the dissemination of configuration information among devices of the communications platform of FIG. 1A;

FIG. 2 is a diagram illustrating a complex co-site environment/radio system including multiple stove-piped topologies;

FIG. 3 is a system diagram illustrating an example of an RF communications platform integrating a spectrum controller for spectrum management;

FIG. 4 is a diagram illustrating the hypothetical operation of an RF communications platform alongside which a spectrum controller is implemented; and

FIG. 5 is a block diagram illustrating a spectrum controller architecture in accordance with an exemplary embodiment.

### DETAILED DESCRIPTION OF THE PREFERRED EMBODIMENT(S)

Out-of-channel energy, often from other co-sited transmitters can take various forms, such as wideband noise, harmonics, intermodulation products, or spurious outputs (also known as “spurs”), etc. While such forms of interference are understood to those skilled in the art of radio frequency communications, the prevention of these forms of interference and mitigation of their effects requires additional specialized knowledge.

Co-sited radio system topologies are often implemented in a fashion where radios are grouped into sets on the basis of radio performance and usage capabilities. For example, usage examples by which radios may be grouped include UHF band radios, air traffic control VHF radios, etc. These radio sets are often connected to their antenna feed-lines through RF aggregators and mixers (also referred to herein as “multicouplers”). Multicouplers are one type of co-site mitigation technology. An example of a multicoupler design can be seen in the following document: “Frequency Hopping Transciever Multicoupler Design”, DoD contract DAAK80-80-C0588, March 1983, which is incorporated herein by reference.

Consistent with the concept of “stove-piped” radio topologies, it should be noted that one more radios or radio elements contained within a stack may be interchangeably referred to herein as part of a “group”. By way of example, radio elements associated signal processing means contained within one stack may form a first group, whereas radio elements and other associated signal processing means contained in another stack, which do not consider RF dynamics of the first stack, may be considered part of a second group. It should be appreciated by those of ordinary skill in the art that a system, such as an RF communications platform may conceivably be configured with any number of groups of radios or radio elements.

Traditionally, the grouping of radios into sets based upon radio performance and usage results in radio system topologies whereby radio sets and their RF paths are implemented in a “stove-piped” fashion. For instance, radios may be stove-piped in the sense that RF dynamics involving one set of radios and its connected filters, amplifiers, switches, multicouplers (which often have internal amplifiers of their own), and antennas (among other devices) do not consider RF dynamics taking place in another set of radios and its connected filters, amplifiers, switches, multicouplers, antennas and other devices.

Proposed herein is a spectrum management device for co-site interference mitigation that has a continuous and dynamic view of multiple radio sets other emitters (including radars, jammers, etc.), and other devices such as multicouplers, filters, amplifiers, etc. Armed with this dynamic view, knowledge of the full RF co-site environment, and possibly combined with other information (e.g. configuration, decisional history, etc.) the spectrum management device is capable of dynamically generating spectrum control information which enables mitigating co-site interference.

Because legacy co-site systems commonly exhibit stove-piped topologies, their RF control strategies are correspondingly myopic. This commonly results in radio receivers receiving excessive RF energy from other emitters outside its radio set. The resultant problems include excessive receiver desensitization, errors in data communication, unintelligible voice, reduced receive range, adjacent channel interference (also referred to herein as “bleed-over,” or the spilling-over of transmissions onto nearby receive channels in an undesired fashion), decreased mean time to failure, and other problems. Since the proposed spectrum management device has a dynamic view of the RF environment on the platform, it is able to mitigate these problems through (1) control over (and of) emitters with consideration of the dynamic vulnerabilities of receivers outside their stove-pipe; (2) control over (and of) receivers with consideration of the dynamic impact from emitters outside their stove-pipe; (3) control over (and of) both receivers and emitters with consideration of the combined dynamic impacts of receivers and emitters within and outside their stove-pipe; and (4) control mechanisms that consider and prioritize factors such as; RF waveform specific impacts, frequency hopping dynamics, channel dwell time, specific radio vulnerabilities/weaknesses, site characteristics (antenna placement, RF shadowing/attenuation, etc.), mission priorities, link/channel usage durations, signal-to-noise measurements, received signal strength indicators, battle-short modes, and other relevant factors.

It should be noted that in frequency hopping systems, the timing and location within the RF spectrum of frequency hops that have not yet occurred are often known by some components of a radio system, such as the transceiver, but may not be known by other components. The ability of the components that have knowledge of future frequency hops to communicate future spectrum usage to the Spectrum Management Device is beneficial to the operation of the Spectrum Management Device.

Traditional solutions to the co-site problem may call for a mixed bag of various techniques that fail to fully address the resulting interference. These shortcomings may be rooted in one or more of various sets of assumptions.

One such assumption is that radios that are co-sited have compatible modes of operation. Consider a case where a co-site environment has two radios or radio sets, wherein the radio sets operate in different spectral bands (also referred to herein as “frequency bands”, or simply “bands”). In a hypothetical configuration, a set of VHF band radios capable of transmitting in a VHF band such as 108 to 156 MHz, and is co-sited with another set of UHF band radios capable of operating in a frequency range of 225 to 400 MHz. Within this hypothetical configuration, one ubiquitous technique is for one radio in transmit mode to blank the other receivers in the same band. Blanking a receiver causes the radio that is blanked to not receive and prevents the radio from being desensitized by the energy from the other radio transmitting in the same band. A severe example of receiver desensitization arises when two co-sited transceivers are both tuned to the same frequency, and one radio transmits while the other receives at the same frequency tuned. In poorly designed radios, this could even damage a receiver. In better designed radios, operation over the same channel generally results in overloading of radio receivers, sometimes with a painful level of audio output if a radio operator is listening with headphones. The problem is still very much present, but with less consequences the further in frequency one radio transmitting is from another co-sited radio in receive.

Blanking the receiver is one technique connected to the assumption that co-sited radios have compatible modes of operation. For example, if a VHF radio is transmitting on 123.0 MHz, the other VHF radios on the same platform, may have their receivers blanked. This is a technique commonly used in General Aviation, and was commonly used in older military fighter aircraft. One simple way of implementing this method in a radio system having two radios is to simply connect the push-to-talk (PTT) output of one VHF radio to the other VHF radio's blanking input, and visa-versa. Blanking one radio's receiver while the opposite radio is transmitting may be disadvantageous, however, if both radios must necessarily operate at the same time. For example, this may be undesirable in a pilot/co-pilot scenario. If a pilot is talking to air traffic control (ATC) using one radio's transmitter, and the co-pilot is listening to a radio receiving broadcast weather information using the other radio's receiver, portions of the broadcast weather information may not be heard by the copilot while the copilot's radio receiver is blanked.

Another assumption is that radios operating in different frequency bands mitigates co-site interference by virtue of band separation. This may hold true in some circumstances, but interference may still arise under this assumption. In another hypothetical configuration involving co-sited single band VHF and UHF radios, harmonic frequency products may produce interference that affects what would ordinarily be an out-of-band receiver. Referencing the example posed above, in which one of the VHF radios is transmitting on 123.0 MHz, harmonic energy from transmission will be present at integer multiples of the fundamental 123.0 MHz frequency. In other words, UHF receivers tuned on or near to 246.0 MHz (2×123.0 MHz) will likely receive the transmission and either corrupt what is being otherwise received (on 246.0 MHz in the example) or worse yet, cause the receiver itself to become desensitized. Even if the “in-band” radio receivers are blanked, the “out of band” receivers can still become victims to this characteristic of the co-site problem. Similar harmonic interference issues exist with co-sited operation of multiband capable radios.

Yet another assumption is that the placement of antennas from different radio types which are placed on different locations on the vehicle (such as an aircraft fuselage), so that one antenna is in the “shadow” of another antenna, is fully effective in mitigating co-site interference. In other words, one antenna may be placed on the top of the fuselage, and another might be placed on the bottom of the fuselage. Alternatively, one antenna might be placed on the left wing, and the other on the right wing. In this scenario, the fuselage may assumedly attenuate the signals between the two.

In a practical matter, full attenuation cannot be achieved through shadowing, antenna placement, or other physical isolation strategies. Rather, attenuation is a measured quantity, and isolation gained between two antennas still presents receive energy from one antenna to the another. For example, if there is 65 dB of isolation between two antennas, and one antenna is radiating 10 Watts (+40 dBm), it can be assumed that the victim antenna will be exposed to a signal level of −25 dBm (+40 dBm minus 65 dB of isolation). It should be noted that −25 dBm is, for VHF and UHF operations, a relatively strong received signal strength. Even with external filtering, antenna factors, and polarization losses, there is sufficient energy at the victim receiver to expose co-site issues.

Yet another assumption is that co-site interference is mitigated by frequency hopping. Frequency hopping is a common technique in which radios are configured with a “hop-set”, which is a time-domain mapping of frequency assignment (“channel”). This designated frequency/time mapping is designed such that one radio (which might be transmitting) stays out of another radio's receive channel and that near-channel interference is avoided ahead of time. Some solutions may assume that radios are using the same “hop-set”, and thus avoid each other's receive path.

This is not the case, for example, for single channel radios on a flight deck, which are routinely tuned to frequencies used by ATC. Those frequencies are assigned by ATC based upon an aircraft's position within a sector of airspace. In the current state of the art, hop sets are often impossible to design with full and dynamic awareness of usage of single, fixed channels, and frequency hopping taking place on other radio sets on the same platform. It is therefore possible that hopping receivers can be desensitized during a receive operation when a frequency hop is scheduled in the same frequency, a harmonic frequency, or nearby frequency as a fixed channel in which a transmit operation is ongoing. In an analogous fashion, a frequency hopping radio operating in transmit mode may momentarily hop onto the same channel, or deliver energy to a harmonic frequency, used by a fixed channel receiver. If sufficient energy is coupled into the fixed channel receiver, it may also become desensitized. It is additionally possible for radios that are operating two different hop-sets to have such transmit/receive frequency collisions.

Yet another assumption is that a multicoupler device will, like a silver bullet, fully mitigate co-site interference problems. The multicoupler is by far the currently most complex and expensive component in many co-site solutions. Radio systems are often designed using topologies that link sets of radios to one multicoupler.

A multicoupler takes RF (transmit and receive) signals from one or more radio transceivers and conditions the signals to minimize interference between each other. Such signal conditioning may include phase cancellation, various filter methods, delays, amplification, and/or regeneration, as well as many other methods. Multicouplers are fittingly named because their high-level role includes coupling a set of multiple radios together and coupling (join) to shared antenna(s).

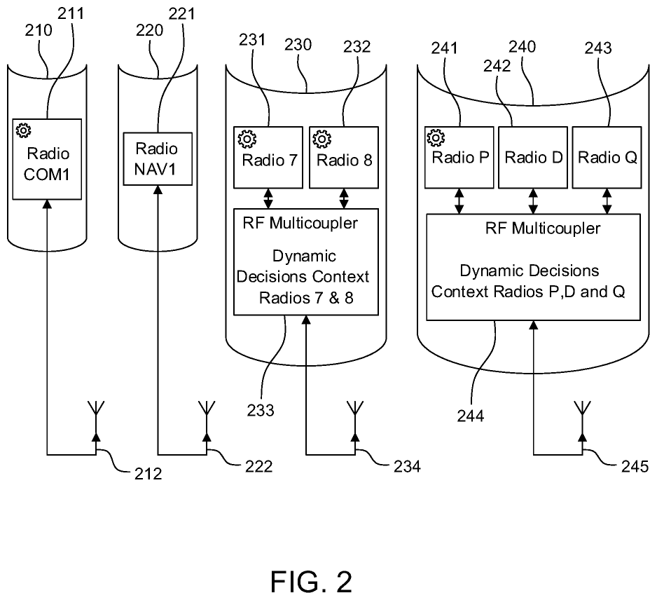

It should be noted that complex co-site environments or radio systems can include multiple radio topologies that are co-located. For example, aircraft platforms with 20 or more radios, designed in several radio sets (with their connected equipment) are common. Examples of radio systems having multiple radio topologies are illustrated in FIGS. 2, 3 and 4, and are described in greater detail below.

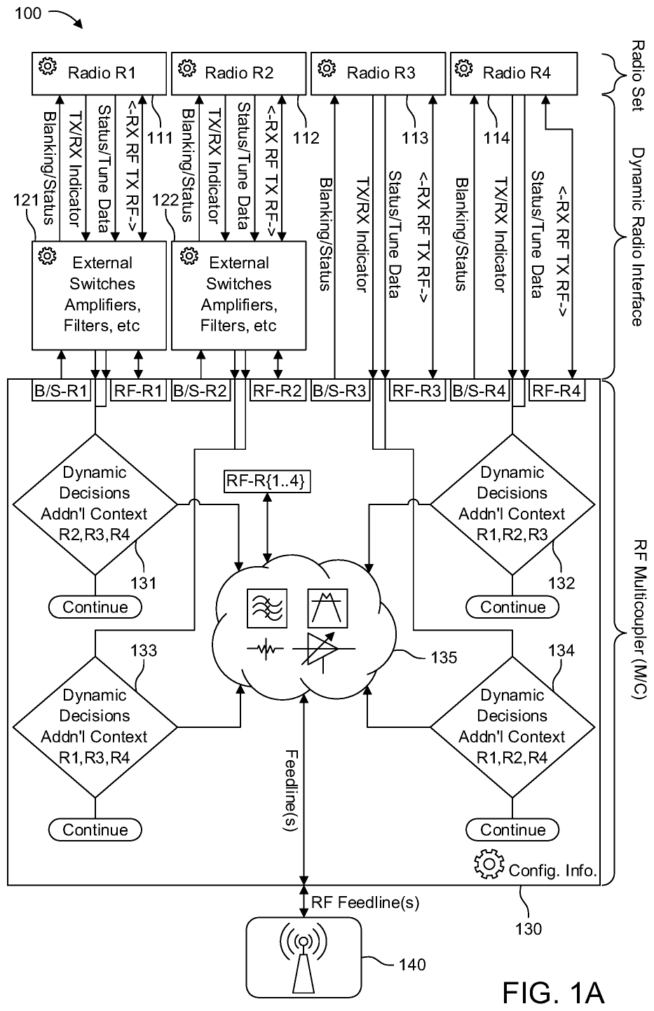

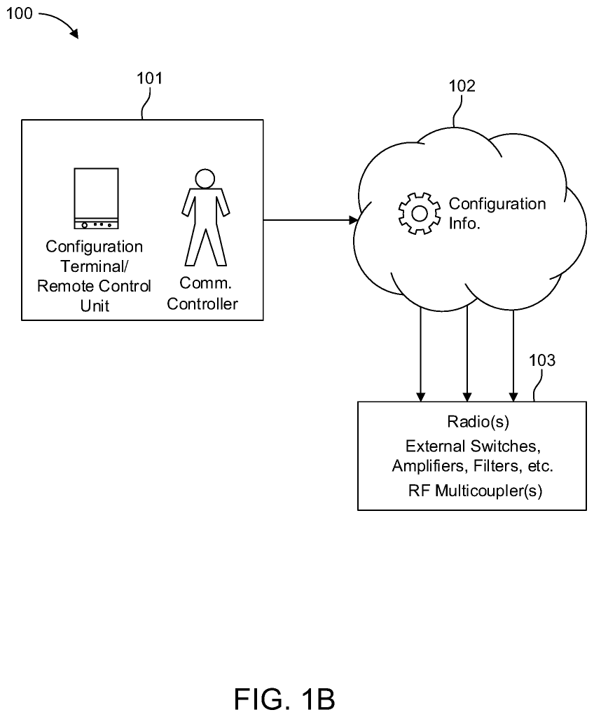

FIG. 1A is a diagram illustrating one example of a co-site environment at a communications platform. The co-site environment 100 includes a single radio set including radios R1, R2, R3, and R4 (illustrated respectively by elements 111, 112, 113, and 114). The co-site environment further includes an RF multicoupler 130, which is further coupled to at least one antenna (or multiple co-sited antennas) shown at 140 via one or more feedlines and RF feedlines. Radios 111, 112, 113, and 114 dynamically interface with the RF multicoupler 130, for example, directly or through external switches, amplifiers, filters, or other components. As shown in FIG. 1A, radios 111 and 112 interface respectively with sets of external devices 121 and 122, which in turn communicate with the RF multicoupler 130. By contrast, radios 113 and 114 interface directly with the RF multicoupler 130.

It should be noted that FIG. 1A is representational of the current state of the art, and illustrates only a single radio set topology and a single multicoupler. It should be further noted that the transceiver interfaces in FIG. 1A are generalized, and that although a single connection to the antenna is shown, switching and filtering of antenna feedline(s) may be implemented for the radio topology and multicoupler shown.

A multicoupler receives dynamic information from each individual radio. This information can be carried through various interface forms. The interface forms may be, for instance, simple discrete digital lines, serial busses such as RS-485, RS-422, MIL-STD-1553, a mixture of both discrete and serial lines, or other interface forms. The information is dynamic, and may change in tandem with changes in radio frequency, which can be extremely rapid and continuous. For example, in the case of fast frequency hopping modes, frequency hopping may occur many multiple of times per second. Alternatively, the multicoupler can dynamically receive information from individual radios, but less rapidly, such as when a pilot tunes a flight deck radio to another air traffic control frequency. The dynamic information includes attributes such as: a transmit (TX) or receive (RX) indicator; the frequency to which the radio is tuned; desired transmit power level; received signal strength; and/or a variety of other radio status information.

The multicoupler's “dynamic decisions” consider each radio's status. For example, the multicoupler may detect when two radios attempt to transmit on the same frequency at the same time. Those skilled in the art will appreciate that such circumstances require action to prevent such a frequency collision (e.g. blanking one radio's transmission, or combining signals with carrier phase synchronization, or other forms of interference mitigation), and any action may be carried out in concert with externally connected switches amplifiers and filters.

Another illustration of the multicoupler's decision making is when one radio is transmitting on the same frequency while another is receiving either on the same frequency, or a nearby frequency exposing the receiver to the transmitting radio's adjacent channel interference. Those skilled in the art will appreciate that techniques of signal filtering, attenuation, splitting, mixing, and/or RF path management, along with other techniques is required to be performed by the multicoupler, and in some cases in concert with externally connected switches amplifiers and filters to mitigate the impending co-site interference. For example, a notional multicoupler (e.g., consistent with FIG. 1A, 130) may be configured to carry out RF control methods to mitigate co-site interference through the use of tunable filters, programmable attenuators, controllable amplifiers, phase control/cancellation, or other methods (FIG. 1A, 135). Accordingly, the multicoupler is capable of mixing, splitting, dividing, and controlling RF energy as needed to and from the antenna feed line(s) along transmit and receive paths. The notional multicoupler is shown in FIG. 1A with four notional radios (111, 112, 113, 114), two notional external signal conditional blocks consisting of switches/amplifiers/filters (121, 122). Signal conditioning components between the radio and multicoupler may or may not be required or implemented by the designer. Furthermore, those skilled in the art will know that a multicoupler connects a plurality of radios, and the choice of four radios shown in FIG. 1A is purely arbitrary for notional purposes. It should be noted that the radios depicted in FIG. 1A, may also be referred to herein, as “radio elements”

Signaling conducted via the dynamic radio interface is described in greater detail has follows. Similarly as described above, and with reference to FIG. 1A, radios 113 and 114 dynamically provide or receive signals (TX and/or RX signals) directly to/from the multicoupler 130 (i.e., shown at RF-R3 and RF-R4). The radios 113 and 114 also provide TX/RX indicators to the multicoupler 130 along with radio status and tuning data. The TX/RX indicators and radio status and tuning data form a context at the multicoupler that is associated with each of the radios 113 and 114. Inside the multicoupler dynamic decisions are made based on the various radio statuses, and the output of these decisions form the basis for control of the multicoupler.

Radios 111 and 112 dynamically send or receive signals (TX and/or RX signals) to/from external devices 121 and 122, respectively. Although generalized in the illustration of FIG. 1A, the external devices 121 and 122 may include one or more external switches, amplifiers, or filters, or other forms of signal conditioning, for example. Similar to radios 113 and 114, radios 111 and 112 provide TX/RX indicators to their respective external devices 121 and 122 along with radio status and tuning data. The external devices 121 and 122 are configured to provide TX/RX indicators and radio status and tuning data to the multicoupler.

The external devices 121 and 122 dynamically send or receive signals (TX and/or RX signals) between radios 111 and 112 the multicoupler 130 (i.e., the TX/RX interfaces at the multicoupler are illustrated at RF-R1 and RF-R2). Each of the radios 111, 112, 113, and 114 are configured to receive blanking/status signals from the multicoupler (e.g., via the B/S-R1, B/S-R2, B/S-R3, and B/S-R4 interfaces). In the case of radios 111 and 112, the external devices 121 and 122 are configured to receive blanking/status signals from the multicoupler via the B/S-R1 and B/S-R2 interfaces and, in turn, send blanking/status signals to the radios 111 and 112. Blanking of the radios 111, 112, 113, and 114 may be carried out substantially as described in paragraphs above.

As described above, the multicoupler is configured with dynamic decision-making logic, as shown at 131, 132, 133, and 134. For example, dynamic decisions dictate RF control operations of the multicoupler 130 as well as blanking/status signals that are sent towards the radios 111, 112, 113, and 114 based on contextual information gathered from the radios. The contextual information includes RF information obtained via the RF-R1, RF-R2, RF-R3, and RF-R4 interfaces, as well as TX/RX indicators and status/tune data.

In the example shown in FIG. 1A, the dynamic decision-making logic 131 considers contextual information associated with radio 111. If appropriate, to mitigate active or impending interference, the logic 131 controls blanking/status signals for any one of the radios 111, 112, 113, or 114, or external devices 121 or 122. Alternatively, or additionally, the logic 131 controls RF energy using one of the techniques available to the multicoupler. If no interference is detected, the decision making logic 131 may continue monitoring the contextual information. The dynamic decision-making logic 132, 133, and 133 may operate in a similar manner, each respectively considering contextual information associated with radios 112, 113, and 114.

Individual radios or transceivers operate asynchronously from each other. For example, if two radios are operating in a frequency hopping fashion, the radios are expected to perform tuning hops to different frequencies and at different points in time. In addition, other radio system attributes may vary dynamically from radio to radio. It is the multicoupler's role to ensure that the RF is controlled such that the desired performance of the radio set is achieved. The desired performance is often a function of a complex trade-space. Trade-space priorities may be one attribute of configuration information, typically setup by a user of the system. This user may be referred to as the “communications control technician.”

FIG. 1B is a diagram illustrating the dissemination of configuration information among devices of the communications platform of FIG. 1A. The communications platform, depicted in FIG. 1A and operating within the co-site environment 100, includes various devices that may be configured by a user, for example, to observe trade-space priorities. For instance, FIG. 1A denotes that radios 111, 112, 113, and 114, as well as external devices 121 and 122 and multicoupler 130 are all capable of accepting such configuration information. As shown in FIG. 1B, the co-site environment 100 is administered by a communications controller operating a configuration terminal 101. The communications controller, via the configuration terminal, generates configuration information 102 including parameters to be observed by the devices 103 of the communications platform. The devices include radios, external switches, amplifiers, as well as multicoupler devices. The parameters included in the configuration information 102 may include, for example, channel assignments, frequency hopping patterns and timing information; or frequency band restrictions, and other static configuration information necessary for radio operation. It should be noted, however, that the configuration information 102 is distinct from the dynamic contextual information upon which the multicoupler bases its decision-making.

FIG. 2 is a diagram illustrating a complex co-site environment/radio system including multiple stove-piped topologies. Here, FIG. 2 presents a macro level view of several co-located radio/multicoupler/antenna topologies, each similar to that illustrated in FIG. 1A. It should be noted that while the different topologies may be capable of sourcing configuration information from a single configuration terminal, the system illustrated in FIG. 2 is not capable of sharing dynamic information between the stove-piped topologies.

As shown in FIG. 2, the system includes multiple stove-piped “stacks” of connected equipment, including groups of one or more radios (equivalently referred to as “radio elements”) and connected equipment. Radio 211 (COM1) is implemented in one such “stack” of connected equipment 210 that is associated with an antenna 212 (or, alternatively, a common set of antennas, which may include two or more co-sited antennas). The same can be said of stack 220, which includes radio 221 (NAV1) and is associated with antenna 222s. In a more complex example, stack 230 includes a group of two radios 231 (radio 7) and 232 (radio 8), a single RF multicoupler 233, and antenna 234. The RF multicoupler 233 is configured to dynamically control each of the radios using the information received via interfaces with the radios 231 and 232. For example, the RF multicoupler is configured to detect impending co-site interference between radios 231 and 232 based on the dynamically received information (e.g., spectrum usage, TX/RX indicators, etc.), and, if necessary, to take action to mitigate such impending interference. The RF multicoupler transmits or receives RF signals via antenna 234.

In a similar fashion, stack 240 includes a group of three radios, radio 241 (radio P), radio 242 (radio D), and radio 243 (radio Q). Each of the radios 241, 242, and 243 are coupled via RF multicoupler 244. The RF multicoupler 233 is configured to detect impending co-site interference and execute RF control methods and/or blanking to dynamically mitigate such interference.

Each of the stacks 210, 220, 230, and 240 are stove-piped in that each stack does not dynamically communicate with another stack. It should be noted that at least one of the stove-piped stacks 210, 220, 230, and 240 (including, for example their associated radio elements, antennas, multicouplers, and/or other hardware) may be co-sited as part of an RF communications platform. As illustrated in FIG. 2, radios 211, 231, 232, and 241 are denoted as being configurable by a comm. controller, for example, to administer trade-space priorities. As described substantially in paragraphs above, however, such configuration does not provide the same advantages of true dynamic spectrum management.

A key aspect of the system design illustrated in FIG. 2 is that radiated emissions (i.e., between antennas, which are intentional radiators of RF energy) lead to co-site interference because the different stovepipes do not share dynamic information shared between them. This heightens the likelihood of inter-frequency “collisions”, harmonic interference, and adjacent channel interference. There also exists the possibility for interference from unintentional emitters in these systems, as well as interference from RADAR equipment or electronic warfare emitters.

A shortcoming of existing systems is that is that the multicoupler alone is assumed to fully mitigate co-site interference problems. As detailed substantially in paragraphs above, there are several cases in which co-site interference may persist despite attempts at mitigation through, e.g., blanking, frequency hopping, and other RF control techniques as may be implemented by a multicoupler. Thus, there is a need for a solution that goes beyond the multicoupler-centric paradigm.

Solutions proposed herein take a different technical approach than stove-piping information down the multicoupler alone. For example, a solution for mitigation of co-site interference as proposed herein may take into account a holistic view of a co-sited radio environment. One solution is a spectrum management device that receives frequency usage data from emitters (including radios, radio elements, groups of radio elements, radars, jammers, etc.) and receivers (including radios, warning receivers, radars, etc.), ideally capturing usage data from all radios on the platform. This data may be in the form of dynamic packets of information that inform the spectrum management device where (i.e., in terms of frequency) transmitters (radios, radio elements, groups of radio elements, jammers, radars, etc.) are emitting (i.e., both currently and in the future) or where receivers (radios, radio elements, groups of radio elements, warning receivers, radars, etc.) are receiving (i.e., both currently and in the future). The spectrum usage data may further include information about the waveform (e.g. modulation, signal strengths, characteristics, etc.) that emitters are currently transmitting (or will transmit in the future) or the waveform that receivers are currently receiving (or will receive in the future). The spectrum usage data may include a duration of transmit/receive operations and/or define windows in time for such operations. The spectrum usage data may be in the form of radio output data associated with different radios, radio elements, groups of radio elements, radio stacks, jammers, radars, etc. Additional information such as signal level, modulation, bandwidth, waveform, duration, receive signal strength, or other RF information or parameters are made available to the spectrum management device. A function of the spectrum management device is to aggregate all of the received RF spectrum context information.

Information in the packets regarding the signal level, modulation techniques, bandwidth, waveform and duration of the upcoming transmission, are dynamic in nature. The delivery of certain types of information might compress the time between the packet being received at the spectrum controller and the beginning of a transmission. For example, the dynamic information associated with an upcoming transmission may become available to the spectrum controller when the upcoming transmission is scheduled to commence or even arrive after the transmission has begun. In essence, radios and other emitter or receiver devices within the communications platform provide the spectrum controller all information that the device has, or can share, about the spectrum usage in a dynamic and real-time fashion.

The spectrum controller is positioned to be aware of the dynamics of many or all of the radios, radio elements, groups of radio elements, receivers, radar devices, and other emitters present in the co-site environment and therefore to manage both the emitter outputs and receiver (radio, radio element, radar, warning receiver, etc.) inputs. The spectrum controller is also in a position to know, through configuration information and rules of the vehicle or site, where the vulnerabilities are. Based on dynamic determinations considering waveform, radio band, radio type and other factors that interference will occur (e.g., between radios or radio elements of different groups/stove-pipes/stacks), the spectrum controller is then able to send signals across the radio stack stove-pipes indicating parameters for for mitigating interference (i.e., data, configuration info, spectrum control actions, or spectrum control recommendations) in an intelligent fashion. Emitters and/or receivers that receive such signals from the spectrum controller may send or receive transmissions in accordance with the received signal from the spectrum controller, for example, implementing the indicated parameters to mitigate interference.

Those skilled in the art will also recognize that stove pipes may not only include radio stacks, but stove-pipes also may also include other RF equipment such as radars, and electronic warfare systems.

Cross stove-pipe intelligence allows for more creative mitigation of co-site problems, and may allow for one or more of the following real time and adaptive methods: transmit filtering (of course), attention, transmission denial (TX blanking), receive blanking, and the use of intelligent duration and placement of spectral energy, among other techniques. These techniques may enable mitigation across boundaries of radio band (including upper harmonics) and across traditional co-site device types.

Existing solutions are not broadly holistic, but rather are themselves stove-piped (e.g., tending to be stove-piped either to a specific type of transceiver or band usage). In other words, existing co-site solutions may only work for one transceiver type, or for one band. By contrast, the proposed solutions offer a completely holistic approach to addressing co-site interference and removes the spectrum “blinders” or co-site paradigms (e.g., hopsets that are designed to avoid each other, multicoupler boxes, or radio blanking). Thus, the primary functions of a proposed spectrum management device include continuous aggregation of RF spectrum usage, continuous intelligent spectrum control to minimize co-site inference, and continuous dissemination of spectrum control actions and recommendations to participating devices.

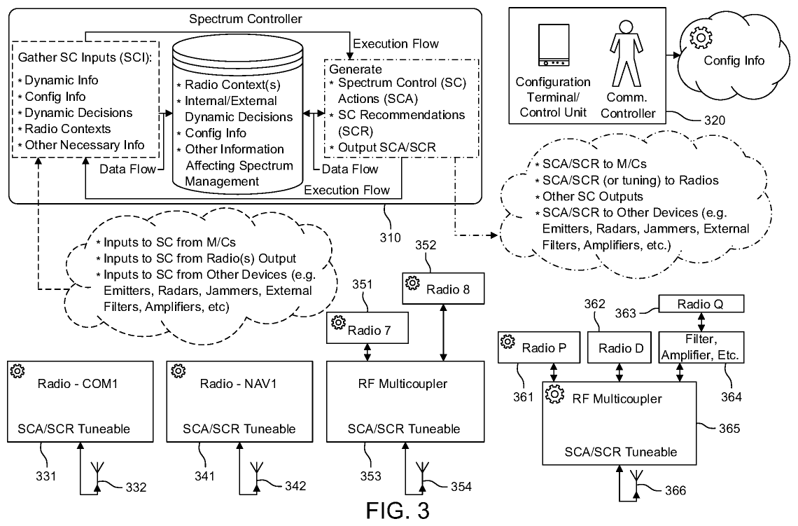

FIG. 3 is a system diagram illustrating an example of an RF communications platform integrating a spectrum controller for spectrum management. As shown in FIG. 3, the system includes the spectrum controller 310, radio 331 (COM1), radio 341 (NAV1), radio 351 (radio 7), radio 352 (radio 8), radio 361 (radio P), radio 362 (radio D), radio 363 (radio Q), RF multicoupler 353. Radios 331 and 341 are standalone radios (each considered to form a group including a single radio element), with each respectively coupled via feedlines to antennas 332 and 342. Radios 351 and 352 form a group of two radio elements and are each coupled to RF multicoupler 353, which in turn is coupled to antenna 354. Radios 361 and 362 form another group of two radio elements, and are each coupled to RF multicoupler 365, which in turn is coupled to antenna 366. Radio 363 is coupled to external signal conditioning equipment 364 (e.g., an amplifier, filter, or another device), which in turn is coupled to the RF multicoupler 365.

The RF multicouplers 353 and 365 each dynamically control radios and external equipment within their respective stacks similarly as described in paragraphs above. It should be noted that, as shown in FIG. 3, the radios and multicouplers are no longer stove-piped because the spectrum controller 310 is dynamically controlling (in a holistic fashion) the other radio stacks. Therefore, it is possible for equipment within the radio stacks to dynamically receive signals providing spectrum control actions (SCA) and spectrum control recommendations (SCR) from the spectrum controller, and the SCAs and SCRs are intelligently constructed to mitigate or minimize co-site interference across radio stacks. For example, the spectrum controller is configured to send signals issuing SCAs and/or SCRs directly to radios 331 and 341 such that the radios may be dynamically tuned/blanked and controlled by the spectrum controller as needed, and to the RF multicouplers 353 and 365, which in turn control radios 351 and 352. The spectrum controller is configured to send signals to issue SCAs and/or SCRs directly to the RF multicouplers 353 and 366, which in turn respectively control radios 351 and 352, and radios 361, 362, 363, and external equipment 364.

The data and execution flows of the spectrum controller are as follows. The spectrum controller first gathers spectrum control inputs (SCI), which include dynamic information, configuration information, dynamic decisions, radio contexts, and other necessary information. The spectrum controller receives such information from a variety of sources including: multicouplers, radios, and other devices such as emitters, RADAR equipment, jammers, external filters, amplifiers, and other devices.

Having obtained the spectrum control inputs, the spectrum controller formulates radio context information, internal/external dynamic decisions, all the while considering configuration info, and other information affecting spectrum management. The spectrum controller generates and outputs the SCAs and/or SCRs. The SCAs and/or SCRs (as well as other spectrum control information) are issued to compatible devices including: multicouplers, radios, and other external devices. This process will repeat continuously as the spectrum controller dynamically evaluates the co-site environment.

It should be noted that the work of the spectrum controller can be speed-intensive. For perspective, consider a hypothetical scenario in which radio 331, is tuned to a fixed channel, radio 351 performs frequency hopping using a waveform that requires 100 hops per second, and perhaps radios 361, 362 and 363 are using a different waveform that hops, perhaps much faster or many times times faster. In this scenario, the spectrum controller must track each of the dynamic frequency hops, and tune/re-tune radios as frequency collisions and band separation criteria are violated. The SC must also contemplate information regarding future hops and frequency usage.

Although not illustrated in FIG. 3, it is possible that the controller will receive dynamic information related to other emitters on the same platform (such as RADAR emitters, electronic warfare emitters/jammers, warning receivers, and/or other devices). The spectrum controller may need to continuously and rapidly provide SCRs and SCAs to RF devices, especially multicouplers, to support its RF conditioning and spectrum duties. It is necessary that the rapidity of processing complements the hop rate of frequency hopping systems and waveforms such that the recommendations or control actions arrive in time to be processed by the multicouplers, external filters/devices, or the radios. A key benefit is that the entire system is no longer stove-piped in its spectrum management view.

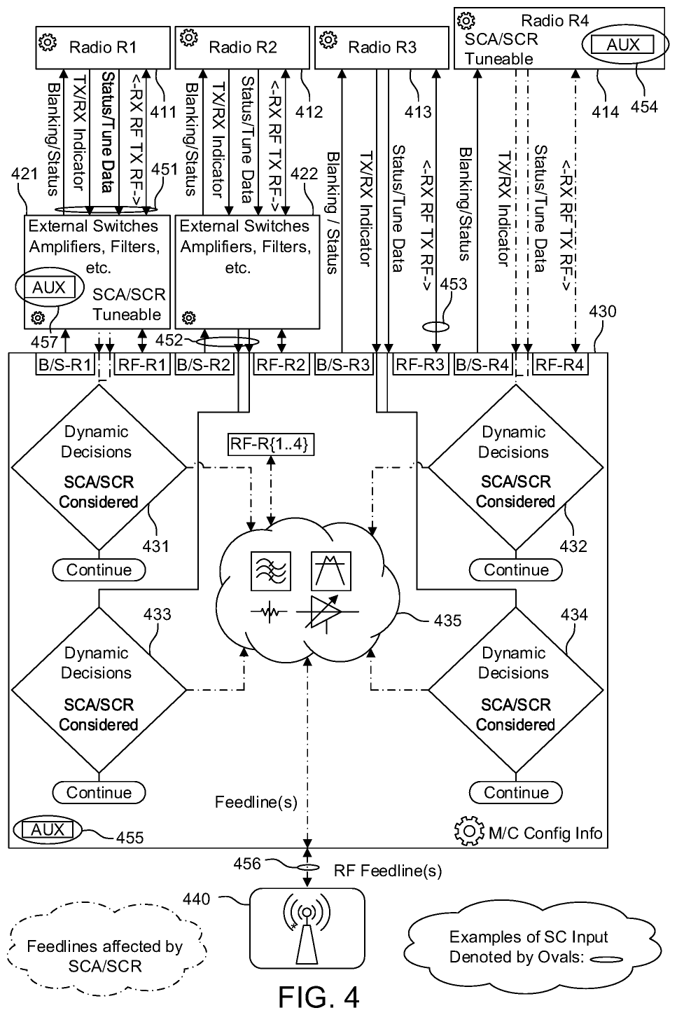

FIG. 4 is a diagram illustrating the hypothetical operation of an RF communications platform alongside which a spectrum controller is implemented. The RF communications platform includes radio 411 (referred to as radio R1 in FIG. 4), radio 412 (referred to as radio R2 in FIG. 4), radio 413 (referred to as radio R3 in FIG. 4), and radio 414 (referred to as radio R4 in FIG. 4). Radios 411 and 412 each interface respectively with external devices 421 and 422 (e.g., switches, amplifiers, filters, etc.), which in turn communicate with an RF multicoupler 430. Radios 413 and 414 interface directly with an RF multicoupler 430. The RF multicoupler 430 is connected via feedlines to at least one antenna 440. The RF multicoupler 430 is further connected to a spectrum controller (not depicted in FIG. 4) by the AUX interface 455.

FIG. 4 shows data interfaces that can provide dynamic information to the spectrum controller through as planned and architected as part of the base design of a radio system or radio system components. Such interfaces are illustrated by way of example in FIG. 4 at elements 454, 455, and 457. Notwithstanding data domain-to-data domain conversions between these interfaces and the spectrum controller itself (such as serial data to TCP/IP packets, and similar conversions), planned and architected interfaces present to the system designer a relatively straightforward path to spectrum controller interfacing. The spectrum controller may be configured to store the received dynamic information for usage in mitigating cosite interference.

FIG. 4 also shows data domain interfaces between components of a radio system which may have not been originally planned or architected to provide dynamic input to the spectrum controller. Perhaps lacking original planning in the radio system for interface to the spectrum controller, instead the interface information is generated through various methods of dynamic and continuous harvesting in the data domain including sampling, tapping, discovery, buffering with signal regeneration, interception, of data domain interfaces between radio system components. Harvesting data should commonly take place without altering the signal or changing the operation of the radio system. In other words, these methods should not interfere with the operation of the radio system. One example of a location where such data domain signals have been harvested (in order to generate dynamic input to a spectrum controller) is illustrated at element 452.

FIG. 4 also shows RF domain signal interfaces between radio system components which may have not been originally planned or architected to provide dynamic input to the spectrum controller. Perhaps lacking original planning in the radio system for interface to the spectrum controller, the characteristics of these RF domain signals information are harvested through various methods of dynamic and continuous harvesting including sampling, tapping, discovery, buffering to signal regeneration, interception, analog to digital sampling, peak detection interval, and other methods. This information is used to provide continuous dynamic information for data input to the spectrum controller. This harvesting may yield information on characteristics such as carrier frequency, power levels, transmit status, implied receive status (receive status is implied by lack of transmit power levels, for example), modulation, waveform, and other information useful as input to the spectrum controller. Such harvesting should ideally take place in a location and fashion where performance and operation of the radio system is not adversely affected. FIG. 4 shows several locations where harvesting such RF signal characteristics can be seen, such as 453 and 456. Harvesting of RF signal characteristics can also be seen combined with data (digital) domain harvesting at 451. The spectrum controller may be configured to store the harvested information for usage in mitigating cosite interference.

Some external devices, may generate information for spectrum controller input without having to harvest information from interfaces. For example, with respect to FIG. 4, it should be noted that external device 421 is a device that has an interface 457, which makes it capable of both sending input information to the spectrum controller, and is also capable of receiving and considering SCA and/or SCR (from the spectrum controller), whereas external device 422 may not. Additionally, both digital and RF information may be readily available in an external device, and if more information is available when interfaced to the spectrum controller, then that information could make harvesting in other locations, depending upon the radio system topology, unnecessary.

An additional benefit of having external devices with interfaces to the spectrum controller is that the spectrum control can provide spectrum control information (SCA/SCR) to the external device. In FIG. 4, it should be noted that external device 421 is a device receiving SCA/SCR (from the spectrum controller) whereas external device 422 is not capable of receiving SCA/SCR information. This is indicated by way of the dotted line interface therefore in FIG. 4 for that the information flow between the external device 421 and dynamic decision making logic 431. As mentioned above, it should be noted that external device 422 is not capable of receiving SCA/SCR (i.e., from the spectrum controller). Therefore RF and data (discretes, etc.) provided from the external device 422 and received by the multicoupler 430 will not have considered spectrum control information, and the inputs to the dynamic decision making logic 433 are not conditioned by information from the spectrum controller. This is indicated using a solid line interface in FIG. 4 for the information flow from the external device 422 to the dynamic decision making logic 433. However, dynamic decisions made inside 433 consider the spectrum controller SCA/SCR. For this reason, the outputs of the dynamic decision making logic in 433 are shown in a dotted line.

Radios 413 and 414 dynamically provide or receive RF domain signals (TX and/or RX signals) directly to/from the multicoupler 430 (i.e., shown at RF-R3 and RF-R4). The radios 413 and 414 also provide TX/RX indicators to the multicoupler 430 along with radio status and tuning data. The TX/RX indicators and radio status and tuning data form a context at the multicoupler that is associated with each of the radios 413 and 414.

As can be seen in FIG. 4, the radio 413 interface to multicoupler 430, provides input gathered for the spectrum controller out of RF domain sampling at 453. Contrast this with information gathered out of radio 412 as extracted at 452.

Additionally, FIG. 4 shows harvesting of information from the RF domain and the digital (data) domain from radio 411 in the interfaces at 451. Unlike radios 411, 412, and 413, which cannot directly communicate with the spectrum controller, radio 414 can directly output information to the spectrum controller using interface 454. That interface (454) can be seen in radio 414. Since radio 414 may communicate to the spectrum controller, harvesting of information from interfaces is not seen between radio 414 and multicoupler 430.

Additionally, radio 414 may also receive spectrum control information from the spectrum controller. This makes radio 414 tuneable considering SCA/SCR information from the spectrum controller. Since the RF and digital information from radio 414 considers spectrum control information, interface lines (between radio 414 and multicoupler 430) are seen in FIG. 4 in a dotted line format.

As shown in FIG. 4, the spectrum controller has the ability to communicate to and from the multicoupler 430 using the interface port 455. From this port, SCA and SCR messages may be received. Thus, it can be seen that dynamic decisions (431, 432, 433, 434) in the multicoupler (430) for each of the four radios (411, 412, 413, 414) have the ability to have spectrum controller SCA/SCR considerations applied. Thus, the output of each dynamic decision is shown in FIG. 4 with dotted line format. It may further be seen that the RF feedlines have spectrum controller considerations applied.

Signaling conducted via the dynamic radio interface is described in greater detail has follows. Radios 413 and 414 dynamically send or receive signals (TX and/or RX signals) directly to/from the multicoupler 430 (i.e., shown at RF-R3 and RF-R4). The radios 413 and 414 also provide TX/RX indicators to the multicoupler 430 along with radio status and tuning data. The TX/RX indicators and radio status and tuning data form a context at the multicoupler that is associated with each of the radios 413 and 414.

Radios 411 and 412 dynamically send or receive signals (TX and/or RX signals) to/from external devices 421 and 422, respectively. Although generalized in the illustration of FIG. 1A, the external devices as shown in FIG. 4 by elements 421 and 422 may include one or more external switches, amplifiers, or filters, for example. Similar to radios 413 and 414, radios 411 and 412 provide TX/RX indicators to their respective external devices 421 and 422 along with radio status and tuning data. The external devices 421 and 422 are configured to provide TX/RX indicators and radio status and tuning data to the multicoupler.

The external devices 421 and 422 dynamically send or receive signals (TX and/or RX signals) between radios 411 and 412 the multicoupler 430 (i.e., the TX/RX interfaces at the multicoupler are illustrated at RF-R1 and RF-R2).

Each of the radios 411, 412, 413, and 414 are configured to receive blanking/status signals from the multicoupler or external devices. The external devices 421 and 422 are configured to receive blanking/status signals from the multicoupler and in turn send blanking/status signals to the radios 411 and 412. Blanking of the radios 411, 412, 413, and 414 may be carried out substantially as described in paragraphs above.

The multicoupler is configured with dynamic decision-making logic, as shown at 431, 432, 433, and 434. For example, dynamic decisions dictate RF control operations of the multicoupler 430 as well as blanking signals that are sent towards the radios 411, 412, 413, and 414 based on contextual information gathered from the radios. The contextual information includes spectrum usage information, which may indicate parameters to be used by each of the radios or by groups of radios deployed at the RF communications platform for sending or receiving transmissions. For example, the contextual information may include RF information obtained via the RF-R1, RF-R2, RF-R3, and RF-R4 interfaces, as well as TX/RX indicators and status/tune data.

In the example shown in FIG. 4, the dynamic decision-making logic 431 considers contextual information associated with radio 411. If appropriate, to mitigate active or impending interference, the logic 431 controls blanking/status signals for any one of the radios 411, 412, 413, or 414, or external devices 421 or 422. Alternatively, or additionally, the logic 431 controls RF energy using one of the techniques available to the multicoupler. If no interference is detected, the decision making logic 431 may continue monitoring the contextual information. The dynamic decision-making logic 432, 433, and 433 may operate in a similar manner, each respectively considering contextual information associated with radios 412, 413, and 414.

Importantly, FIG. 4 illustrates examples of signals that serve as inputs to the spectrum controller. Radio 414, for instance, includes a dedicated output 454 for the spectrum controller. The dedicated output provides a direct interface with the spectrum controller such that the spectrum controller is readily able to obtain, e.g., status/tune data, TX/RX indicators, and other RF parameters from the radio 414. The external device 421 includes an auxiliary output that can be utilized by the spectrum controller to harvest spectrum usage data from the external device or from the radio 412 that is connected to the external device. Furthermore, the RF multicoupler itself includes also includes an auxiliary output that provides spectrum usage data for use by the spectrum controller.

It should be appreciated that conceivably any output between components (e.g. radios, filters, multicouplers, emitters, jammers, radars, etc.) presents an opportunity for an input to the spectrum controller. An electrical engineer will understand that the harvesting of information by the spectrum controller is more easily done using digital interfaces (using techniques such as Y cables, sampling, tapping, buffering to signal regeneration, with impedance matching as needed) than it is done with RF interfaces. When implementing the proposed spectrum controller in an existing system, interfaces between components may be repurposed such that the spectrum controller can obtain the holistic information required. Dedicated and “designed-in” interfaces, such as output 454, for example, may present less difficulty to the design engineer, while processing techniques may be necessary to harvest spectrum usage data from RF interfaces that are not purposefully designed to accommodate the spectrum controller.

FIG. 4 further illustrates components that are capable of accepting SCAs and/or SCRs provided by or forwarded by the spectrum controller as well as paths (i.e., denoted in FIG. 4 by dashed lines) that are directly affected by SCAs/SCRs. In the example depicted, only radio 414 supports spectrum control actions (SCA). In other words, of the radio transceivers, only radio 414 is capable of being tuned and controlled by the spectrum controller. Such control is received by radio 414 on the interface 454. External device 421 (e.g., switch/amplifier/filter) connected to radio 411 is shown as being capable of accepting both SCAs and SCRs. Such control is received by external device 421 on interface 457.

In comparison with the communications platform illustrated in FIG. 1A, FIG. 4 illustrates a platform having a multicoupler with more robust spectrum controller support. It should be noted that each of the decision logic 431, 432, 433, and 434 operate with consideration of SCAs and SCRs. The outputs of the decisional logic, which control the RF section of the M/C, are therefore directly affected by the spectrum controller. Furthermore, multiple levels of spectrum control may be implemented, such as where M/C is slower to tune or operate than the radio, or vice-versa, or other dynamics specific to the radio equipment or RF switches and external modules.

The proposed solutions break the paradigm of stove-piped topologies in the current state of the art. A benefit is the radio system ensure recommendations and actions (SCRs/SCAs) are issued in as many places as necessary or possible in order get the highest level of co-site performance possible. A further benefit is that the SCA/SCR and methods mitigate problems, such as harmonic interference, out of band interference, frequency collisions, help with co-site issues from other interferers such as co-sited RADAR emitters or EW jammers that may be unaccounted-for in traditional interference mitigation techniques. Since the notional RF control methods enjoy the full benefit of dynamic decisions, which further benefit from the logic of the spectrum controller, a multicoupler is better able to dictate mitigation techniques that account for more sources of interference within the co-site environment.

Platforms that especially stand to benefit from the proposed solutions include those operated by the United States Air Force (USAF) and North Atlantic Treaty Organization (NATO) as well as Coalition Forces high-value co-site systems, such as aircraft carriers, Joint Surveillance and Target Attack Radar System (JSTARS), Airborne Warning And Control System (AWACS), and various other command and control vehicles (e.g. High Mobility Multipurpose Wheeled Vehicles (HMMWVs), Bradley Fighting Vehicles, and M1 Abrams tanks with command nodes).

Although many of the examples provided herein consider military and intelligence use cases, the proposed solutions may be relevant to any RF communications platform that implements multiple co-sited topologies. For example, the proposed solutions may be useful in the consumer electronics and telecommunications realms, and use cases may exist for systems capable of parallel communication using different wireless protocols such as IEEE 802.11 Wireless Local Area Network (WLAN) protocols, Bluetooth, cellular protocols such as 4G Long-Term Evolution (LTE) and 5G New Radio (NR); satellite communication; and Global Navigation Satellite Systems (GNSSs).

Those of skill in the art will understand that one or more hardware features of the disclosed solutions may be implemented in software while remaining consistent with the description provided herein. For instance, a radio as described herein may include an RF front end, an analog-to-digital converter (ADC) and/or a digital-to-analog converter (DAC), a digital front end, as well as a general purpose processor configured to perform baseband processing traditionally performed by a field programmable gate array (FPGA), application-specific integrated circuit (ASIC), or a digital signal processor (DSP).

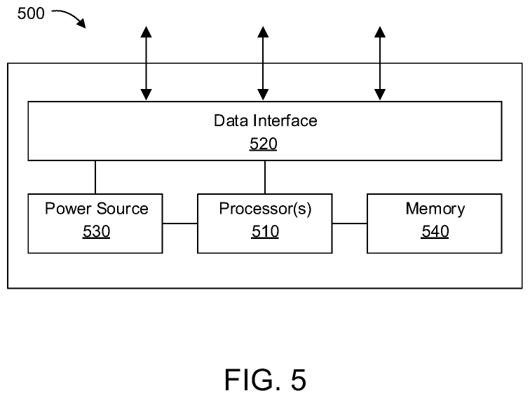

FIG. 5 is a block diagram illustrating a spectrum controller architecture in accordance with an exemplary embodiment. A similar architecture could be used within an RF communications platform, a multicoupler, a switch, a radio, or a radio element to implement decisional logic for interference mitigation methods. A person having ordinary skill in the art may appreciate that embodiments of the disclosed subject matter can be practiced with various computer system configurations, including multi-core multiprocessor systems, minicomputers, mainframe computers, emulated processor architectures, computers linked or clustered with distributed functions, as well as pervasive or miniature computers that may be embedded into virtually any device. For instance, at least one processor device and a memory may be used to implement the above described embodiments. At least a portion of any one of the embodiments described may be implemented using software defined radio (SDR).

A spectrum controller device as discussed herein may include a single hardware processor, a plurality of hardware processors, or combinations thereof. Hardware processor devices may have one or more processor “cores.” The term “non-transitory computer readable medium” as discussed herein is used to generally refer to tangible media such as a memory device 540. The hardware processor may or may not have an RF front-end integrated with it—that is, the processing of collected data may occur either in the device with the antenna directly attached to it, or on another processor device operating on previously collected signal data.

The spectrum controller contains one or more processors 510, which may include one or more both of a hardware processor and a hardware FPGA, which can be a general purpose processor device and a special purpose device, respectively. The processor 510 is connected to a data interface 520, which is configured to allow packets and signals to be transferred between the spectrum controller 500 and external devices. Data transferred via the interface 520 may be in the form of signals, which may be electronic, electromagnetic, optical, or other signals as will be apparent to persons having skill in the relevant art. The signals may travel via a communications path, which may be configured to carry the signals and may be implemented using wire, cable, fiber optics, a phone line, a cellular phone link, a radio frequency link, etc. Though not shown, the data interface may include one or more antennas coupled to a transceiver or an RF front end.

The spectrum controller 500 includes a memory 540 (e.g., random access memory, read-only memory, etc.), and may also include one or more additional memories. The memory 540 and the one or more additional memories may be read from and/or written to in a well-known manner. In an embodiment, the memory 640 and the one or more additional memories may be non-transitory computer readable recording media.

Data stored in the spectrum controller 500 (e.g., in the memory 540) may be stored on any type of suitable computer readable media, such as optical storage (e.g., a compact disc, digital versatile disc, Blu-ray disc, etc.), magnetic tape storage (e.g., a hard disk drive), or solid-state drive. An operating system can be stored in the memory 540.

Memory semiconductors (e.g., DRAMs, etc.) may be means for providing software to the spectrum controller 500. Computer programs (e.g., computer control logic) may be stored in the memory 540. Computer programs may also be received via the data interface 520. Such computer programs, when executed, may enable the spectrum controller 500 to implement the present methods as discussed herein. In particular, the computer programs stored on a non-transitory computer-readable medium, when executed, may enable hardware processor device 510 to implement functionally illustrated by FIGS. 1A, 1B, 2, 3, 4, and 5, or corresponding methods, as discussed herein. Accordingly, such computer programs may represent controllers of the spectrum controller. Where the present disclosure is implemented using software, the software may be stored in a computer program product or non-transitory computer readable medium and loaded into the spectrum controller 500 using a removable storage drive or data interface 520.

The spectrum controller 500 may also include a transceiver which performs functions pertaining to analog to digital signal conversion. The spectrum controller 500 may also include an RF front end which performs RF signal processing functions on an RF signal. The spectrum controller 500 may also contain a power device 520 which powers the device to perform its designated functions.

It will be appreciated by those skilled in the art that the disclosed systems and methods can be embodied in other specific forms without departing from the spirit or essential characteristics thereof. The presently disclosed embodiments are therefore considered in all respects to be illustrative and not restricted. It is not exhaustive and does not limit the disclosure to the precise form disclosed. Modifications and variations are possible in light of the above teachings or may be acquired from practicing of the disclosure, without departing from the breadth or scope. Reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

What is claimed is:

1. A radio frequency (RF) communications platform comprising:
a plurality of co-sited antennas;
a first group of one or more radio elements coupled to at least a first one of the plurality of co-sited antennas;
a second group of one or more radio elements coupled to at least a second one of the plurality of co-sited antennas; and
a spectrum controller coupled to at least one of the radio elements of the first group or the second group, the spectrum controller configured to:
receive first spectrum usage data indicating parameters to be used by the first group of one or more radio elements to send or receive transmissions;
receive second spectrum usage data indicating parameters to be used by the second group of one or more radio elements to send or receive transmissions;
dynamically determine, based on the first and second spectrum usage data received in real time, that interference will occur between the one or more radio elements of the first group and the one or more radio elements of the second group; and
forward, to the at least one of the radio elements of the first group or the second group to which the spectrum controller is coupled, a signal indicating parameters for mitigating the interference between transmissions to be sent or received by the one or more radio elements of the first group and the one or more radio elements of the second group;
the at least one of the radio elements of the first group or the second group to which the spectrum controller is coupled and the at least the first one or the second one of the plurality of co-sited antennas further configured to send or receive a transmission in accordance with the signal sent by the spectrum controller.

2. The RF communications platform of claim 1, wherein the first group of one or more radio elements is configured to send or receive transmissions in a first spectral band, and wherein the second group of one or more radio elements is configured to send or receive transmissions in a second spectral band.

3. The RF communications platform of claim 2, wherein the first spectral band is an ultra high frequency (UHF) band, and wherein the second band is a very high frequency (VHF) band.

4. The RF communications platform of claim 1, wherein the first group of one or more radio elements is configured to send or receive transmissions using a first frequency hopping pattern, and wherein the second group of one or more radio elements is configured to send or receive transmissions using a second frequency hopping pattern.

5. The RF communications platform of claim 4, wherein the parameters for mitigating the interference between transmissions sent or received by the one or more radio elements of the first group and the one or more radio elements of the second group include one or more of: filtering parameters, attenuation parameters, transmit blanking parameters, receive blanking parameters, channel assignment parameters, interference cancellation parameters, or timing parameters.

6. The RF communications platform of claim 4, wherein the spectrum controller is configured to forward the signal indicating parameters for mitigating interference directly to the at least one of the radio elements of the first group or the second group.

7. The RF communications platform of claim 1, wherein the spectrum controller is coupled to an external device, and wherein the external device is coupled to the at least one of the radio elements of the first group or the second group so as to control the sending or receiving of transmissions in accordance with the signal forwarded by the spectrum controller.

8. The RF communications platform of claim 1, comprising a multicoupler coupled to at least one of the first or second group of radio elements, wherein the multicoupler is configured to provide spectrum usage data to the spectrum controller, and wherein the multicoupler is configured to condition signals transmitted by at least one of the first or second group of radio elements.

9. The RF communications platform of claim 8, the multicoupler configured to mitigate co-site interference among the first or second group of radio elements to which the multicoupler is coupled.

10. The RF communications platform of claim 1, the spectrum controller configured to receive configuration information from a configuration terminal indicating one or more of: a priority level associated with at least one of the radio elements of the first group or the second group, channel assignment information, channel restriction information, or hop-set information.

11. A spectrum controller comprising:
a processor;
a memory device; and
one or more data interfaces;
the processor configured to receive, via the one or more data interfaces, radio output data associated with a first radio stack;
the processor configured to receive, via the one or more data interfaces, second radio output data associated with a second radio stack;
the processor and the memory device configured to store the received radio output data and the received second radio output data;
the processor configured to determine, based on the stored first radio output data and the stored second radio output data that interference will occur between transmissions to be sent or received by one or more radio elements of the first radio stack and one or more radio elements of the second radio stack; and
the processor configured to send, via the one or more data interfaces, a signal indicating parameters for mitigating the interference between transmissions to be sent or received by the one or more radio elements of the first radio stack and the one or more radio elements of the second radio stack.

12. The spectrum controller of claim 10, wherein the signal indicating parameters for mitigating the interference is sent, via one of the one or more data interfaces, to the one or more radio elements of the first radio stack.

13. The spectrum controller of claim 10, wherein the signal indicating parameters for mitigating the interference is sent, via one of the one or more data interfaces, to a multicoupler coupled to the one or more radio elements of the first radio stack.

14. The spectrum controller of claim 10, wherein the processor is configured to receive, via the one or more data interfaces, the first radio output data by harvesting data transmitted between at least one of the one or more radio elements of the first radio stack and an external device or a multicoupler.

15. The spectrum controller of claim 13, wherein the harvested data comprises a blanking signal, a transmit (TX) or receive (RX) indicator signal, or a radio status and tune data signal.

16. The spectrum controller of claim 13, wherein the harvested data comprises characteristics that describe the radio frequency (RF) transmit or receive signals.

17. The spectrum controller of claim 10, wherein the radio output data is received via a dedicated spectrum control output interface of one of the one or more radio elements of the first radio stack.

18. A spectrum controller comprising:
a processor;
a memory device coupled to the processor;
one or more antennas; and
one or more data interfaces;
the processor configured to receive, via the one or more data interfaces, first spectrum usage data associated with a radio stack;
the processor and the one or more antennas configured to detect radio frequency (RF) energy from at least one external device;
the processor and the memory device configured to store the received first spectrum usage data and to store second spectrum usage data associated with the detected RF energy;
the processor configured to determine, based on the stored first spectrum usage information and the stored second spectrum usage data that interference will occur between transmissions to be sent or received by one or more radio elements of the radio stack and the detected RF energy from the at least one external device; and
the processor configured to send, via the one or more data interfaces, a signal indicating parameters for mitigating the interference between the one or more radio elements of the radio stack and the one or more radio elements of the second group.

19. The spectrum controller of claim 17, wherein the at least one external device is an unintentional emitter.

20. The spectrum controller of claim 17, wherein the at least one external emitter is a radio detection and ranging (RADAR) or electronic warfare (EW) emitter.
